(19) United States
(12) Patent Application Publication
(10) Pub. No.: US 2006/0248002 A1
(43) Pub. Date: Nov. 2, 2006

(54) Business strategy transaction router

(75) Inventors: Roger Summer, Batavia, IL (US); Anthony Dezonno, Bloomingdale, IL (US); Jeff Hodson, Wheaton, IL (US); Sandy Biggam, Bloomingdale, IL (US); Michael Sheridan, Oak Park, IL (US); Mike Hollatz, Huntley, IL (US); Dave Wesen, Channahon, IL (US)

Correspondence Address: Welsh & Katz, Ltd.;Richard J. Gurak, 22nd Floor, 120 South Riverside Plaza, Chicago, IL, 60606, US

(73) Assignee: Rockwell Electronic Commerce Technologies LLC, Wood Dale, IL (US)

(21) Appl. No.: 11/117,662

(22) Filed: Apr. 28, 2005

(51) Int. Cl. G06Q 99/00; G06Q 40/00

(52) U.S. Cl. 705/38; 705/1

(57) ABSTRACT

An improved system and method for routing transactions based on business strategy and the ability to identify how the router selection outcomes meet the objectives of a business strategy. First, identifying business strategies along with key performance indicators (KPI) values. Then associating one or more objectives with one or more strategies on key performance indicators. The next step converts the objectives into routing rules which are sent to a routing engine and the transaction is routed.

### FIELD OF THE INVENTION

The present invention relates to business strategy transaction routers, and more particularly to the ability to route transactions based on the results of business objectives and to identify how the router selection outcomes meet the objectives of a business strategy.

### BACKGROUND OF THE INVENTION

Transaction routers of various types are well known in the art. However, previous transaction routers have some inherent disadvantages. One of the disadvantages with prior solutions is that they lack the ability to demonstrate how business objectives are met with transaction routers and do not dynamically route transactions based on the results of business objectives. In existing methods and systems, various factors are shown along the major strategic objectives, but these objectives are fulfilled through vague and undefined objectives. As such, it is questionable as to their value in actual deployment. Moreso, there is no connection to the impact that the routing of transactions plays in these models. The cause and effect models highlight linkages between various high-level strategic objectives, but the relationships between the objectives, as well as, the business strategies are not apparent. The present invention overcomes these and other problems inherent in existing solutions. In one embodiment, the present invention provides a system for routing transactions based on business strategy by identifying business strategies along with key performance indicators (KPI) values. Then associating one or more objectives. The next step converts the objectives into routing rules which are sent to a routing engine and the transaction is routed.

### BRIEF SUMMARY OF THE INVENTION

A business method and system is provided for routing transactions based on business strategy. The ability to identify how the router selection outcomes meet the objectives of a business strategy is disclosed. First, identifying business strategies along with key performance indicators (KPI) values. Then associating one or more objectives. The next step converts the objectives into routing rules which are sent to a routing engine and the transaction is routed.

### BRIEF DESCRIPTION OF THE DRAWINGS

The invention, together with the advantages thereof, may be understood by reference to the following description in conjunction with the accompanying figures which illustrate some embodiments of the invention.

FIG. 1 is an example of a diagram showing a basic description for an overall process of converting strategic objectives into tactile plans;

FIG. 2 is an example of a diagram showing a hexagon representing the advantages of a business model;

FIG. 3 is an example showing the structure of a business model;

FIG. 4 is an example showing another structure of a business model;

FIG. 5 is an example showing another structure of a business model;

FIG. 6 is an example of a hexagon model;

FIG. 7 is an example of a table showing descriptive relative stratifications of the layers within a facet of the hexagon model;

FIG. 8 is an example of a hexagon model showing identified facets and tactics;

FIG. 9 is an example of an overall data connectivity diagram;

FIG. 10 is an example of a historical database feedback coop;

FIG. 11 is an example of a solution that uses a hexagonal approach to represent user perspectives in a three dimensional pattern;

FIG. 12 shows a chart and corresponding metrics.

### DETAILED DESCRIPTION OF THE INVENTION

While the present invention is susceptible of embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

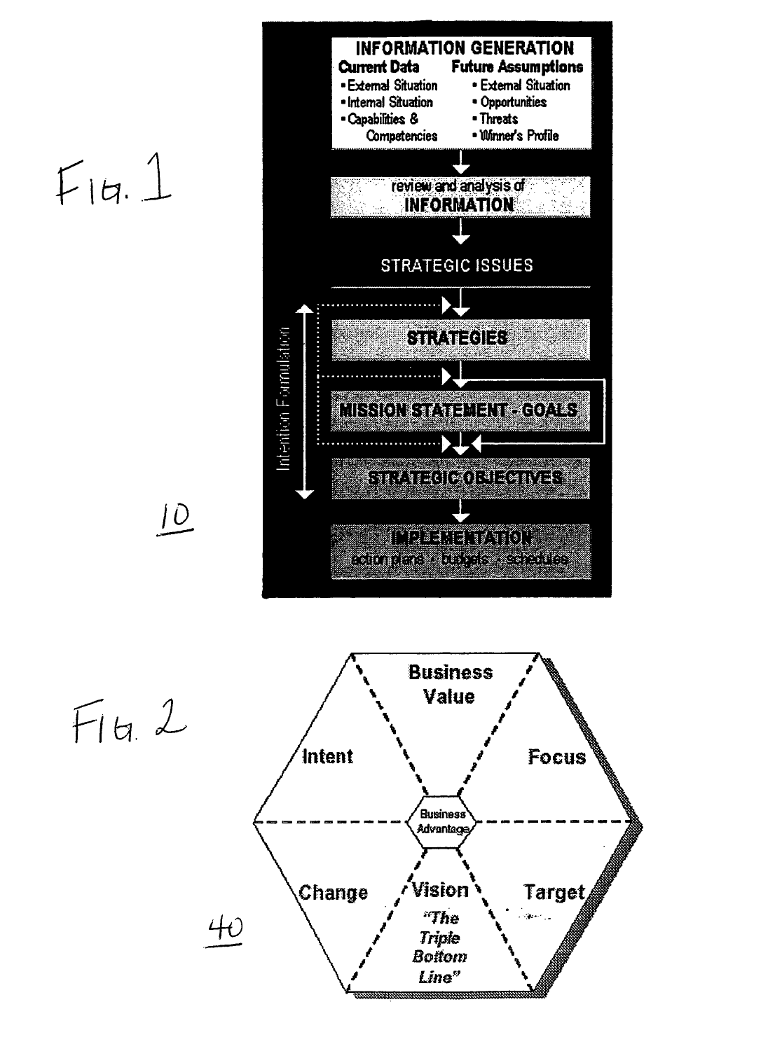

In one embodiment, a system is provided for routing transactions based on business strategy by first identifying business strategies along with key performance indicators (KPI) values. Then associating one or more objectives. The next step converts the objectives into routing rules which are sent to a routing engine and the transaction is routed. A basic description of the process for an overall process of converting strategic objectives into tactical plans is known as is shown in diagram 10 of FIG. 1. In one embodiment, it is useful be able to automatically convert the set strategic objectives into tactical implementations such as routing rules for all customer contact transactions in a business system.

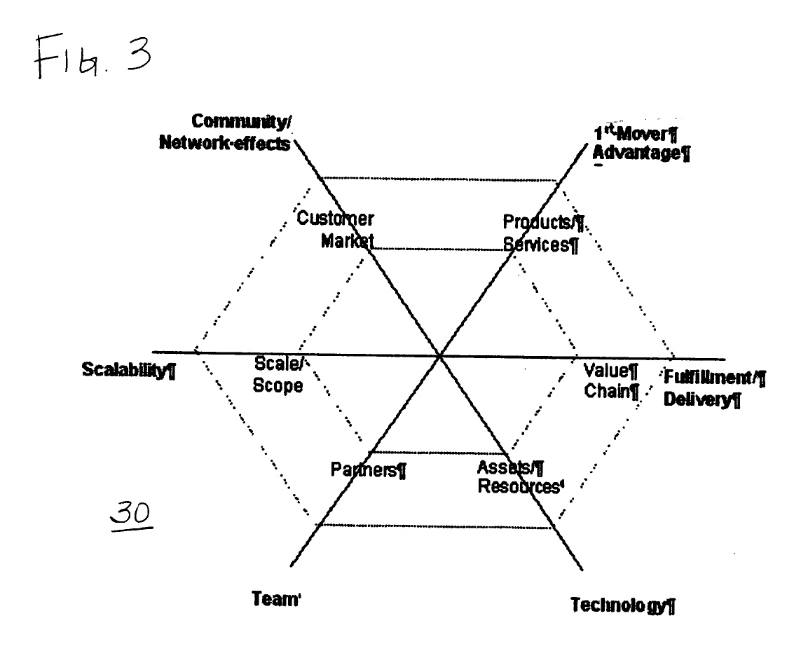

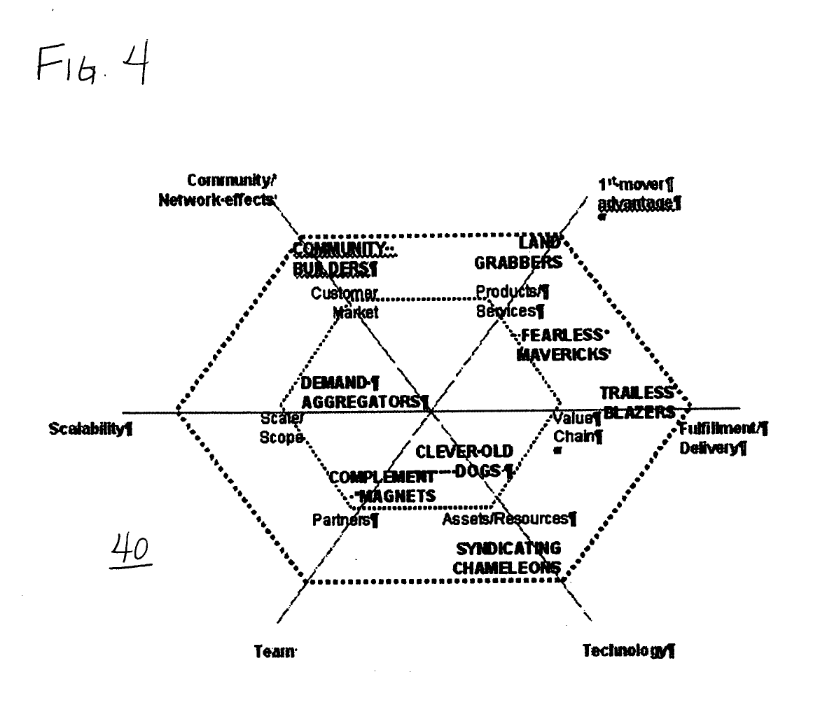

As shown in diagram 20, FIG. 2, in one embodiment approach for representing the advantages of a business model is in the shape of a hexagon. In this approach various aspects or dimensions of a business are represented and in each section it is along an axis from the center to the exterior that a business can measure itself. Multiple and various definitions for these functional quadrants are, for example: Vision: The current ‘triple bottom line’. An Important facet, but not the only facet. Target: Ask is the entity seeking to change the world, a single industry, a single business or a single product line. Different targets require different devices. Focus: Ask is the focus internal (example, the business, shareholders, and/or employees) or external (example, community, customers and/or governments). Business Value: Ask what kind of value do you want to create. (Financial, strategic, or image. Offensive or defensive). These objectives may be clearly defined from the beginning. Intent: Create new business opportunities with the objective of achieving sustainability, or use sustainability to promote opportunities created to achieve other objectives. Change: Ask will the adoption of sustainability occur via a radical shift based on a plateau change, or a slow evolution involving small incremental changes. Alternately, a model can be created for the business in an overall structure shown, for example, in FIGS. 3 and 4 models 30 and 40 are shown.

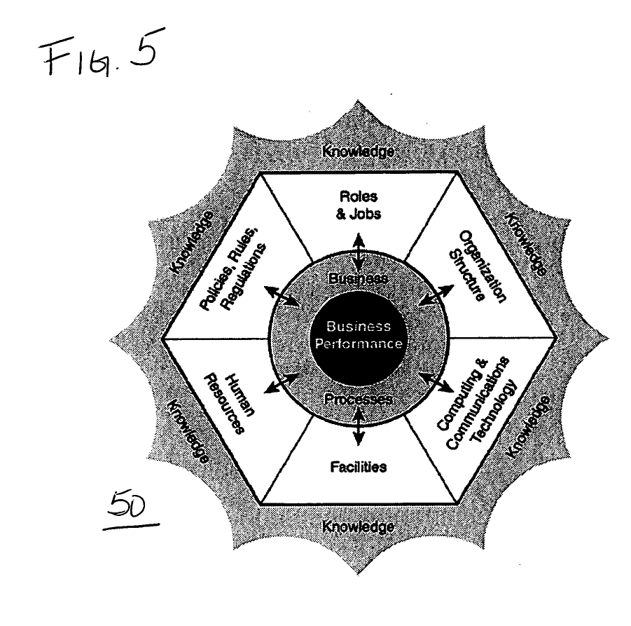

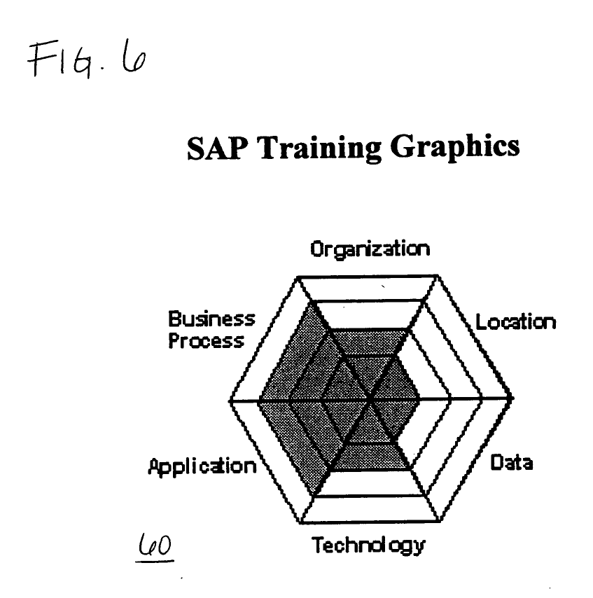

The importance of a particular set of facets may change over time or by functional area and therefore there is a demand that the facets be a programmable parameter as differing forces influence an organization. FIG. 5 shows an example of another graphical business model 50.

Existing solutions lack the ability to clearly show how these facets are fulfilled by the results of the transaction router and therefore it is the objective of this approach to overcome that limitation as described herein. Another disadvantage with existing approaches is that they require expensive customized workflow description of the business model. There are multiple issues in existing approaches in that the integrity of the resulting representation depends on the complete accuracy of the business model created and not all business processes are fully known nor always quantifiable making the model worthless.

In one embodiment, a geometric model may be employed in a hexagonal graphic and used as a display and control forum for an inter facet. The display form itself may display the current maximum capabilities of an organization along the value axis of the facet so that selecting strategic levels within a facet, the selection will show the relative resource requirements and the relative organizational impact from the objective chosen much like a capacity gauge would indicate how able an organization is capable of performing along a given facet.

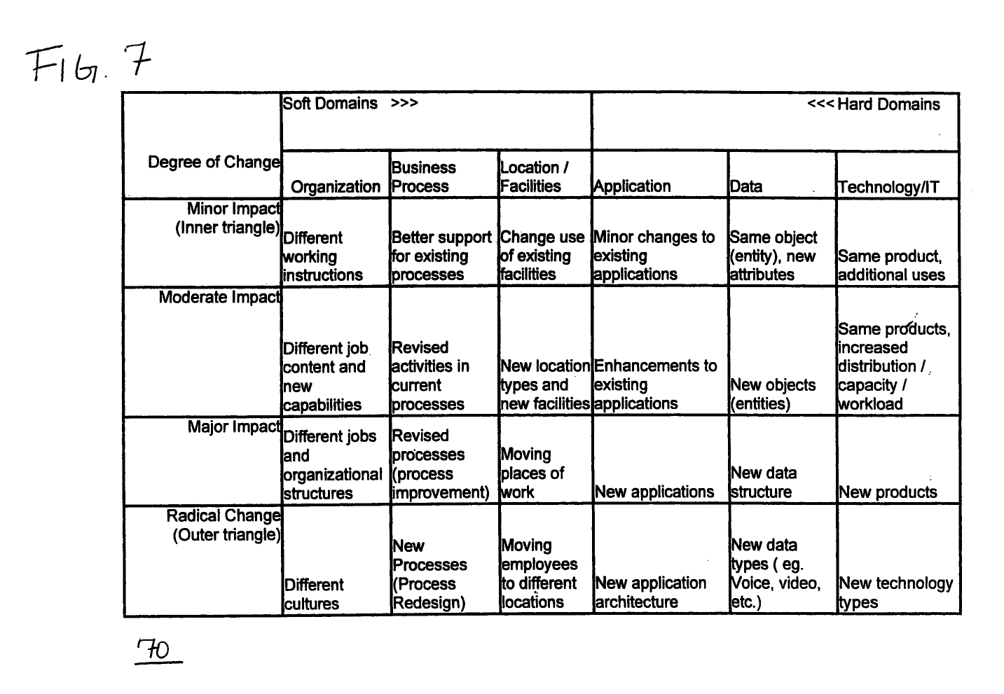

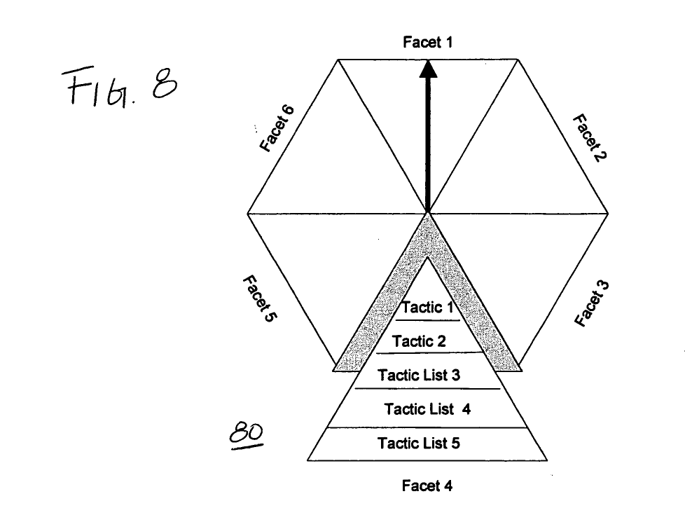

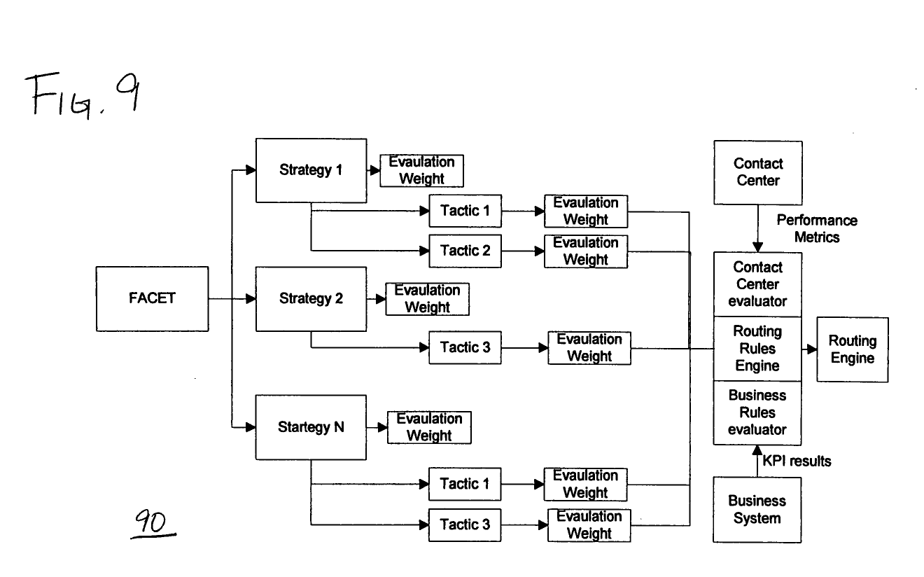

FIG. 6 is yet another example of a hexagon model 60. Table 70, in FIG. 7, shows descriptive relative stratifications of the layers within a facet of the hexagon model. In this example, each of the segments within the facets can be selected and defined by a business. As part of the definition of the facet, it will be associated with various defined strategies that can fulfill maximizing the value of the facet. A standard list of best practice strategies within a business industry can be chosen from a template of existing strategies, or strategies can be defined and then associated with the facet. FIG. 8 shows an example of a hexagon model 80 showing identified facets and tactics. Strategies themselves should be of a measurable form, but they may not necessarily be directly implemented. An important strategy of a business may for example be to increase new accounts by 20%.

Measurable strategies, in one example, should indicate a KPI value chosen from a list of KPI values that have been integrated into the system so that attainment of the KPI can be measured. In one embodiment, one or more strategies are then associated by the system administrator to a free list of one or more tactical objectives in a form like fashion. This can be achieved, in one form, as described in the disclosure of patent application for a Goal Tender System of application Ser. No. 10/903,466 which is hereby incorporated by reference.

Alternately, graphically placing the strategic objective directive within the Hexagon along with a KPI value when shown and interpreted will allow the system to select for the user the best available set of tactical objectives that might meet the strategic objectives. The system will not permit strategies to be placed on the grid that can not be meet with the available amount of resources without signaling this potential error condition to the operator and asking them if its acceptable to proceed under this error condition. This calculation may also use probabilistic models with programmable user triggered thresholds to alter a user for events with probabilities of failure exceeding an established criteria, like where there less than a 90% percent chance of success. The graphical display may display on the grid the locations on the grid, i.e. where enough resources are available, where the strategy can be placed in a different color. Strategies themselves may also be defined a relative importance rating to show the impact of the strategy upon the given business dimension or facet.

Tactical objectives in themselves should always be measurable and specific and should contain an association back to the overall strategic objective. In one embodiment, they will be entered into a form field where the user specifies a particular tactic(s) in a semantic fashion. In one embodiment, a fashion could be described as:

Verb—Quantity—WorkProduct—by Date

Where:

Verb represents the action being accomplished;

Quantity is the measurable amount;

WorkProduct is the deliverable; and

Date is an indication when the measurement period occurs.

One example in this format might be: Reply to 5 emails by Oct. 20, 2003 or Sign-up 2 users by Nov. 01, 2003. When a tactical objective cannot be placed in this form, another tactical objective may be considered or either a constant evaluation weight set or a mathematical function assigned. In this case, the system user or some automated process may set the completion acceptance of the tactical objective or assign a partial value. It is also possible for the quantity to be calculated in a relative manner against an overall quantity measurement (as described in the disclosure of patent application for a Goal Tender System U.S. patent application Ser. No. 10/903,466 which is hereby incorporated by reference). Each of the tactical objectives is then assigned an evaluation weight.

The evaluation weight represents the contribution output of the particular tactic when associated with a particular strategy. The evaluation weight may also be set as a function of the KPI value assigned. When associating a tactic with different KPI's the relative importance of a particular tactic may be greater when using one KPI over another. It is possible that the same tactic may have two different relative values of importance when associated with two different strategies. The evaluation weight may be a constant, a numeric function, or associated with some data outside the program that is accessed through methods such as ODBC. An overall data connectivity diagram 90 is shown in FIG. 9. In yet other embodiments, a predictive or modeling process may be used for calculating the weights or the choice of which tactic or strategy to execute on the transaction (as described in the disclosure of patent application for a Business Analytics Strategy Transaction Reporter Method And System U.S. patent application Ser. No. 11/022,742 which is hereby incorporated by reference.

Once the evaluation weights are configured, a matching function is done within the routing rules engine to assign particular or a group of routing instructions to support each of the combinations of tactics and weights. In some instances it will be relatively straightforward to assign a routing rule to a particular weighted tactic. For example, the tactic of “answer 80% of calls within 20 seconds” may cause the invocation of a routing rule to a particular contact center application where the performance statistic of application is know to meet this criteria. When resources are required for multiple tactics within a strategy, the tactic with the highest score of Strategy Weight multiplied by evaluation weight is shown as being the choice to assign the resource. The user has the option of overriding the resource assignment at this point.

In one embodiment, it is preferred that the routing rules engine contains simulation capabilities (as described in the disclosure of U.S. patent application for a Contact Center Business Modeler application Ser. No. 11/015,410 which is hereby incorporated by reference) in order to best fit available resources to the routing rules. In one embodiment, the routing rules will be able to access a table within the contact center evaluator that contains a data representation of the available resources in the contact center so that as routing rules change and recalculations are performed for routes, the routing rules engine will determine if the contact center has the capacity to meet these new requirements.

This system, in one form, may also be used in a monitoring mode reverse flow data configuration whereby routes generated by the routing engine through some other driver are evaluated against the configuration model represented above. In this case, the evaluation of different routes through the system themselves are declared to have assigned values being driven up through the system model. In one embodiment, different routes to a singular resource might be chosen over time depending on business KPI goal attainment. In this case, the singular resource could have multiple route values as a result. A singular resource may have multiple route values dependant on the current KPI values and goals. The evaluation data and intermediate and result values used in calculating routes (example, current KPI, strategy, tactical, weights, combine total, route selected, route information values) are stored in a historical database as a transaction record to play through in a time based fashion how the contact center met KPI values.

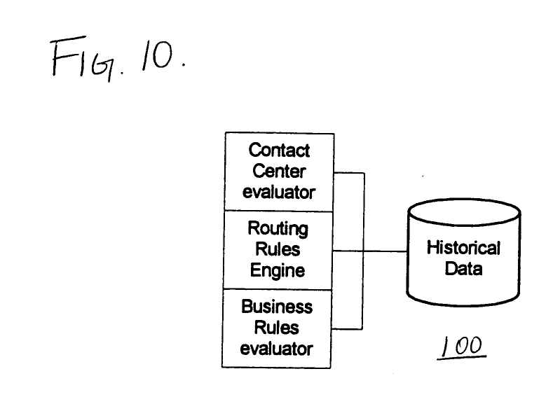

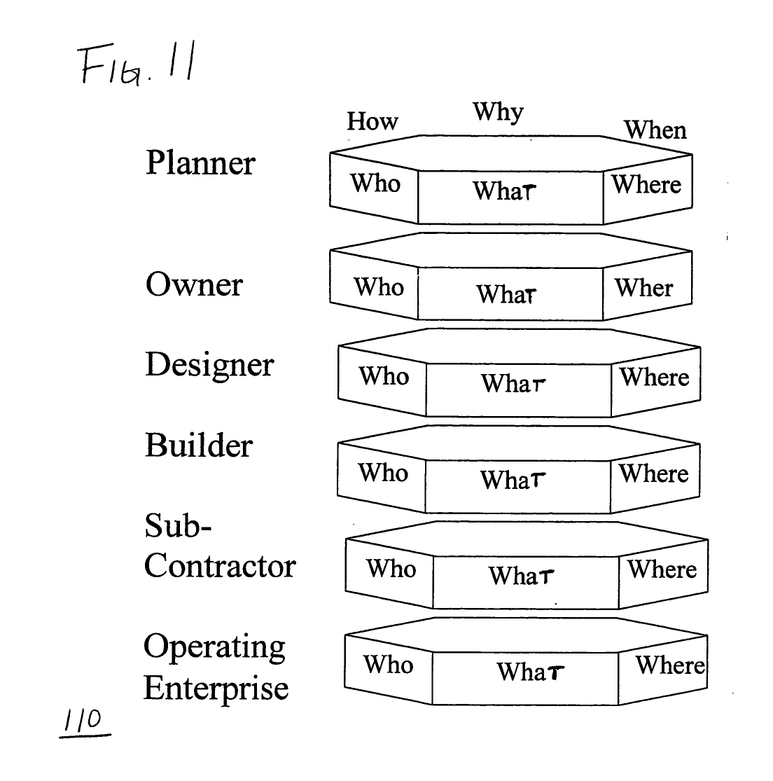

As different business strategies are calculated, or where the configuration does not accomplish the result in KPI values that are the goal of the business strategy, the data of these transactions can be analyzed to identify a cause for this issue. A value assigned to that route choice is then mapped to the appropriate sub tactic of a given strategy. In one embodiment, as shown in FIG. 10, a historical database 100 exists for storing the records of the results connecting to the various engines as shown to create a feedback loop to analyze the effectiveness of prior route calculations.

The playing back in time of the transactions shows how the impacts of the various routing strategies come into play as the KPI values are achieved. The system will show the strategy and tactic directing the route in time periods. The system will evaluate the effectiveness of the model on contact center performance metrics through the use of a contact center evaluator and adjust routing rules in the event of discrepancies of the requirements of the routing rules and the actual system performance. In the example above where calls route to a particular application within 20 seconds, an application meeting this performance requirement may be selected given the non-performance of the application selected in the routing rules. Likewise a business rules evaluator performs a corresponding function on business related data in this model to affect the relationship defined between business and routing rules.

The system, in one form, may have a manner of displaying the results of the hexagonal business system in different user perspective views of the strategies, tactics, and results of concern to the user. The reporting structure presents a summary of the strategies used, their effectiveness against KPI measures and the corresponding tactics deployed with the effect on KPI values as a function of time. In one embodiment, the system will provide perspective. Business strategy can be evaluated and followed using an action engine utilizing a variety of important key metrics for different parts of the organization and how attributes and presence assist to monitor. See FIG. 12, chart 120.

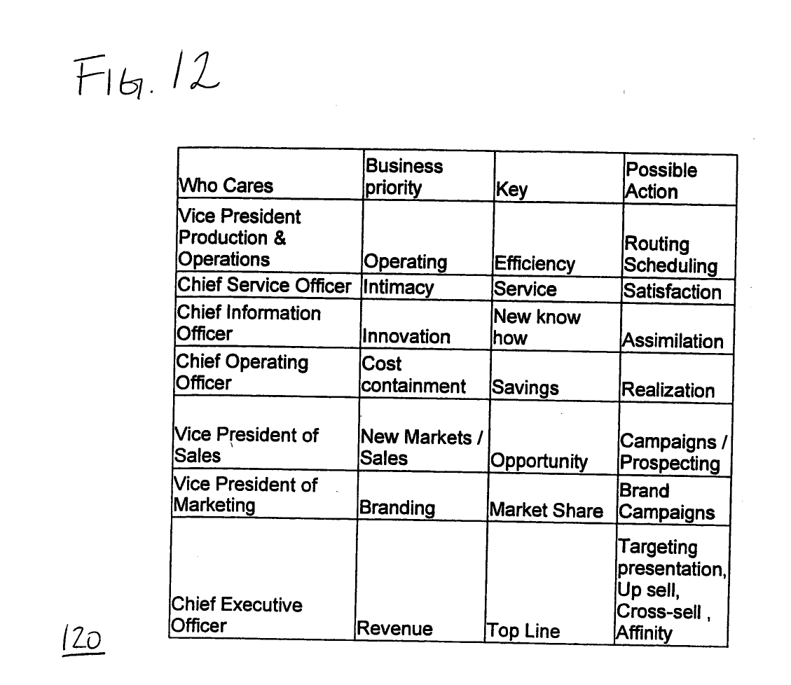

In one embodiment, the BPPerspective column is assigned as a facet dimension, the key column represents possibly both KPI and the strategic objectives, and the possible action category represents tactical objectives that may be built to meet these goals. In planning a hexagon for various perspectives, each user may see views of the data from the perspective that has the greatest impact on their overall performance objects. The view modeler should not alter the structure of the system but allow a user to retrieve the data in the perspective of interest. An example of a solution that uses a hexagonal approach to represent User perspective in a three-dimensional model 110 is shown in FIG. 11.

Alternately, one embodiment is defined in Business Enterprise Architecture Logistics (BEA-LOG) Operational View Model Guide available through the Department Of Defense which is incorporated by reference herein. The BEA-Log is a process-eentric depiction of the future logistics enterprise developed under the auspices of the DoD architecture framework. One focus of this framework is the operational view that depicts the business processes of an enterprise.

With this approach, models have different “views” depending on the aspect of the enterprise being modeled. The views work together to create an integrated portrayal of the enterprise. The DoDAF prescribes three model views as follows: Operational View (OV)—Reflects enterprise entities, activities, business processes, and their interactions; System View (SV)—Addresses information systems and information flow through the enterprise; Technical View (TV)—Reveals the equipment or technical requirements needed. These vantage point allow not only better insight to the model used but also where conflicts could exist in the model in representing the results to a user.

Any of the above methods may, for example, be performed by a source host computer/server, which may also be a router or some other processor using instructions that may reside on a computer-readable medium. The computer readable medium may be any suitable computer readable storage medium such as, but not limited to random access memory, read only memory, flash memory, CD ROM, DVD, solid-state memory, magnetic memory, and optical memory.

Specific embodiments of novel methods and apparatus for construction of novel business strategy transaction routers according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. A method for routing transactions based on business strategies, said method comprising the steps of:
identifying business strategies;
providing a key performance indicator for each strategy;
associating one or more strategies and key performance indicators to one or more objectives;
converting the one or more objectives into routing rules;
sending the routing rules to a routing engine; and
routing a transaction.

2. The method of claim 1 further comprising the step of displaying the business strategies in a geometric shaped model and providing the geometric model as a hexagonal graphic and using the model as a display and control form for an interface.

3. The method of claim 1 further comprising the step of providing a display form showing the current maximum capabilities of an organization along a value axis of a facet and showing the relative resource requirements and the relative organizational impact from the chosen objective.

4. The method of claim 1 further comprising the step of showing descriptive relative stratifications of the layers within a facet of a business model.

5. The method of claim 1 further comprising the step of associating a facet with various defined strategies that can fulfill maximizing the value of the facet.

6. The method of claim 1 further comprising the step of providing measurable strategies indicating a key performance indicator value chosen from a list of key performance indicator values that have been integrated into a system so that attainment of the key performance indicator value can be measured.

7. The method of claim 1 further comprising the step of graphically placing a strategic directive within a business model along with a key performance indicator value to allow a system to select for a user the best available set of tactical objectives that meet the strategic objectives.

8. The method of claim 1 further comprising the step of providing for the graphical display to show available resources on a grid.

9. The method of claim 7 further comprising the step of showing strategies in different colors.

10. The method of claim 1 further comprising the step of providing an evaluation weight representing the contribution output of a particular tactic when associated with a particular strategy.

11. The method of claim 10 further comprising the step of setting the evaluation weight as a function of the key performance indicator value assigned.

12. The method of claim 11 further comprising the step of configuring the evaluation weights and providing a matching function completed within the routing rules engine to assign routing instructions to support each of the combinations of tactics and weights.

13. The method of claim 1 further comprising the step of enabling the routing rules to access a table within a contact center evaluator that contains a data representation of available resources in the contact center to provide for routing rules to change and recalculations performed for routes whereby the routing rules engine will determine if the contact center has the capacity to meet new requirements.

14. The method of claim 1 further comprising the step of providing for the system to be used in a monitoring mode reverse flow data configuration whereby routes generated by the routing engine through a driver are evaluated against the configuration model.

15. The method of claim 1 further comprising the step of using a modeling process for calculating the weights of which strategy to execute on a transaction.

16. A method for routing transactions based on identified business strategies, said method comprising the steps of:
defining business strategies and associated key performance indicators;
entering business strategies and key performance indicator values into tactical objectives;
mapping the key performance indicator values and convert to routing rules;
providing a contact center evaluator, a routing rules engine and a business rules evaluator;
providing data from a historical database and comparison with the generated routing rules and sending to the routing rules engine; and
routing a transaction.

17. The method of claim 16 further comprising the step of displaying the business strategies in a geometric shaped model and providing the model as a hexagonal graphic and using the model as a display and control form for an interface.

18. The method of claim 16 further comprising the step of providing a display form showing the current maximum capabilities of an organization along a value axis of a facet and showing the relative resource requirements and the relative organizational impact from the chosen objective.

19. The method of claim 16 further comprising the step of showing descriptive relative stratifications of the layers within a facet of a business model.

20. The method of claim 16 further comprising the step of associating a facet with various defined strategies that can fulfill maximizing the value of the facet.

21. The method of claim 16 further comprising the step of providing measurable strategies indicating a key performance indicator value chosen from a list of key performance indicator values that have been integrated into a system so that attainment of the key performance indicator value can be measured.

22. The method of claim 17 further comprising the step of graphically placing a strategic directive within a business model along with a key performance indicator value to allow a system to select for a user the best available set of tactical objectives that meet the strategic objectives.

23. The method of claim 17 further comprising the step of providing for the graphical display to show available resources on a grid.

24. The method of claim 22 further comprising the step of showing strategies in different colors.

25. The method of claim 16 further comprising the step of providing an evaluation weight representing the contribution output of a particular tactic when associated with a particular strategy.

26. The method of claim 25 further comprising the step of setting the evaluation weight as a function of the key performance indicator value assigned.

27. The method of claim 26 further comprising the step of configuring the evaluation weights and providing a matching function completed within the routing rules engine to assign routing instructions to support each of the combinations of tactics and weights.

28. The method of claim 16 further comprising the step of enabling the routing rules to access a table within a contact center evaluator that contains a data representation of available resources in the contact center to provide for routing rules to change and recalculations performed for routes whereby the routing rules engine will determine if the contact center has the capacity to meet new requirements.

29. The method of claim 16 further comprising the step of providing for the system to be used in a monitoring mode reverse flow data configuration whereby routes generated by the routing engine through a driver are evaluated against the configuration model.

30. The method of claim 16 further comprising the step of using a modeling process for calculating the weights of which strategy to execute on a transaction.

31. A computer-readable medium having encoded therein computer-executable instructions for performing a method providing routing transactions based on business strategies, the method comprising:
defining business strategies and associated key performance indicators;
entering business strategies and key performance indicator values into tactical objectives;
mapping the key performance indicator values and converting to routing rules;
providing a contact center evaluator, a routing rules engine and a business rules evaluator;
providing data from a historical database and comparing with the generated routing rules and sending to the routing rules engine; and
routing a transaction.

32. A computer-readable medium having encoded therein computer-executable instructions for performing a method providing routing transactions based on business strategies, the method comprising:
identifying business strategies;
providing a key performance indicator for each strategy;
associating one or more strategies and key performance indicators to one or more objectives;
converting the one or more objectives into routing rules;
sending the routing rules to a routing engine; and
routing a transaction.
